(19) United States
(12) Patent Application Publication
(10) Pub. No.: US 2017/0080549 A1
(43) Pub. Date: Mar. 23, 2017

(54) Cabinet Hanging Clamp

(71) Applicant: COLUM RODGERS, Phila., PA (US)

(72) Inventor: COLUM RODGERS, Phila., PA (US)

(21) Appl. No.: 14/835,500

(22) Filed: Sep. 21, 2015

(51) Int. Cl. B25B 11/02; A47B 97/00; A47B 95/00; B25B 7/02; B25B 7/12

(52) U.S. Cl. CPC B25B 11/02; B25B 7/02; B25B 7/123; A47B 95/008; A47B 97/00

(57) ABSTRACT

The part that is new in the art of the Cabinet Hanging Clamp is that it is specifically designed to work on framed cabinets, which would be a very large percentage of cabinets manufactured across the United States and possibly elsewhere. Hundreds of thousands of these cabinets are sold each year to contractors developing apartment buildings, condominiums, or housing developments. This tool attachment will help any person installing the cabinets in these large developments by speeding up the installation time, eliminating the need for help, and will reduce strain on the installer by having to not constantly hold up the wall cabinet by hand to install.

The Cabinet Hanging clamp is a tool created by Colum Rodgers to ease the hanging of framed kitchen wall cabinet (this will not work on frameless cabinets). The tool works in this way a first cabinet must be installed on the wall in the usual manner by holding it up by hand, leveling the cabinet, and screwing the cabinet into the wall. Once that cabinet is installed it then can act as a guide to use the Cabinet Hanging clamp to install all adjoining subsequent cabinets. The clamp is attached to the approximate center of the side panel at the top of the cabinet and has a hook that will allow the entire newly installed cabinet to rest on the cabinet that was previously installed. This allows an installer the opportunity to not have to hold up the cabinet once it is hooked on to the previously installed cabinet, just to screw it into place. This increases the speed of the installation process by keeping cabinets at the same level, and aligned with the front face frame, which allows an opportunity to be hands free temporarily until the cabinet is screwed to the wall and adjoining cabinet.

### CROSS REFERENCE TO RELATED APPLICATION

The customer number associated with this applicant is 00132393. The application number is US62/154,622 with a filing date of Apr. 29, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Cabinet Hanging Clamp was developed to ease the work of a carpenter that installs kitchen wall cabinets, which is the most time consuming and difficult part of kitchen cabinet installation. There is a need to try to speed up installation and ease the installation process. After 20 years of repetitive installation of cabinets, I devised a way to use one cabinet as leverage to install all subsequent wall cabinets. By using my tool, I could install more cabinets without any additional help.

### BRIEF SUMMARY OF THE INVENTION

The Cabinet Hanging Clamp was invented as an attachment to a flat jaw-locking plier, which can be attached to a locking plier using bolts or welded or manufactured as one unit. The clamp locks on the topside panel of a framed kitchen cabinet and acts as a guide and hook to attach to other cabinets. By using this tool, cabinet installation time could be cut by more than half, since it eliminates the need for help, it easily stays aligned with the front face frame of the adjoining cabinet to make shimming and securing to the wall and adjoining cabinet much easier, and eases strain on the carpenter, because they do not have to hold the cabinet in place while attaching the cabinet to the wall or adjoining cabinet.

### BRIEF DESCRIPTION OF SEVERAL VIEWS OF THE DRAWINGS

FIG. 1 is a view of a locking plier and the attachment that is used to hang on to the top approximate center of the side panel on a framed kitchen wall cabinet to ease installation.

FIG. 2 is a side view of the tool, which shows how the clamp attaches on to the top approximate center of the side panel of the framed cabinet before installation.

FIG. 3 Shows the clamp closed on the top approximate middle of the side panel of the uninstalled wall cabinet and you can see the area to the left, so that the cabinet can be lifted, then easily hook on to the top of the side panel on a previously installed adjoining cabinet.

FIG. 4 Shows how the closed clamp would be used to install the cabinet on the right to the previously installed cabinet on the left.

FIG. 5 Shows how the uninstalled cabinet on the right would be hooked easily on to the installed cabinet on the left, then the cabinet can be secured to the wall and adjoining cabinet, then the clamp can be easily removed to repeat the process as needed.

### DETAILED DESCRIPTION OF THE INVENTION

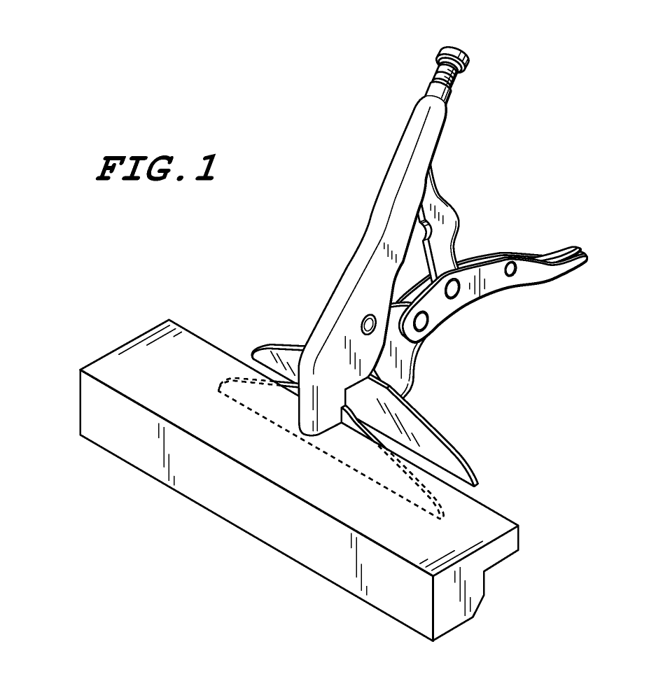

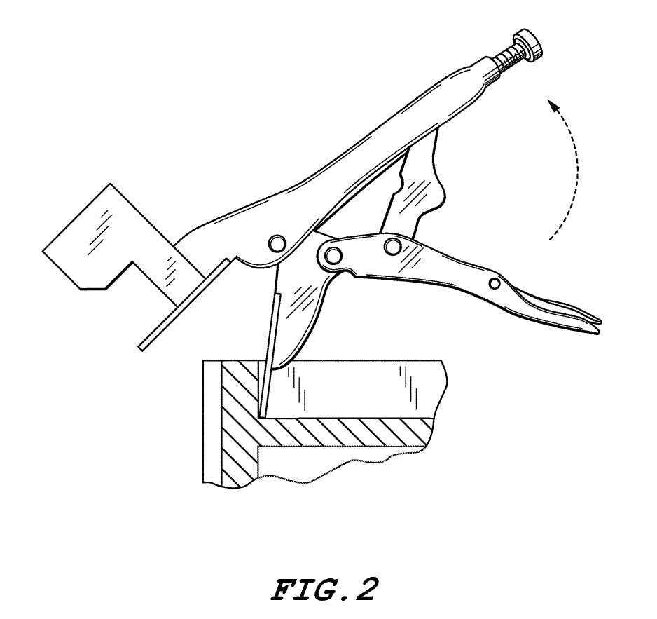

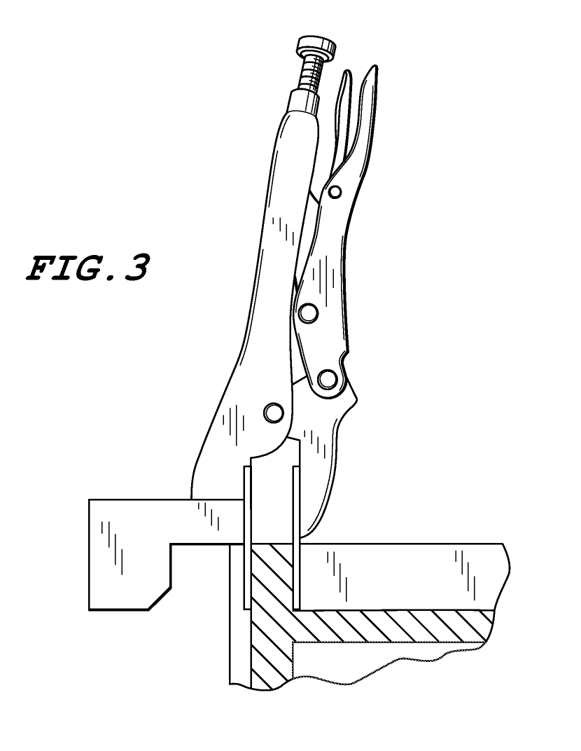

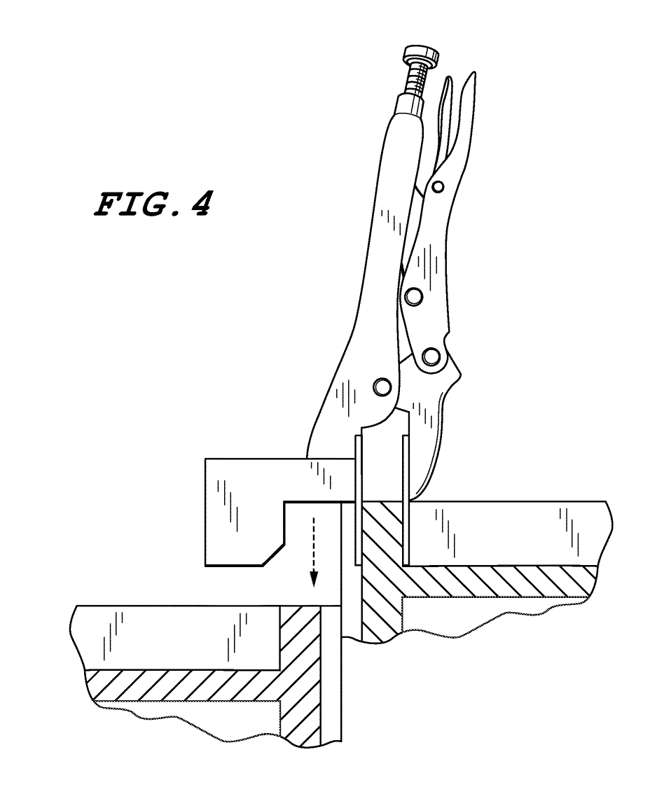

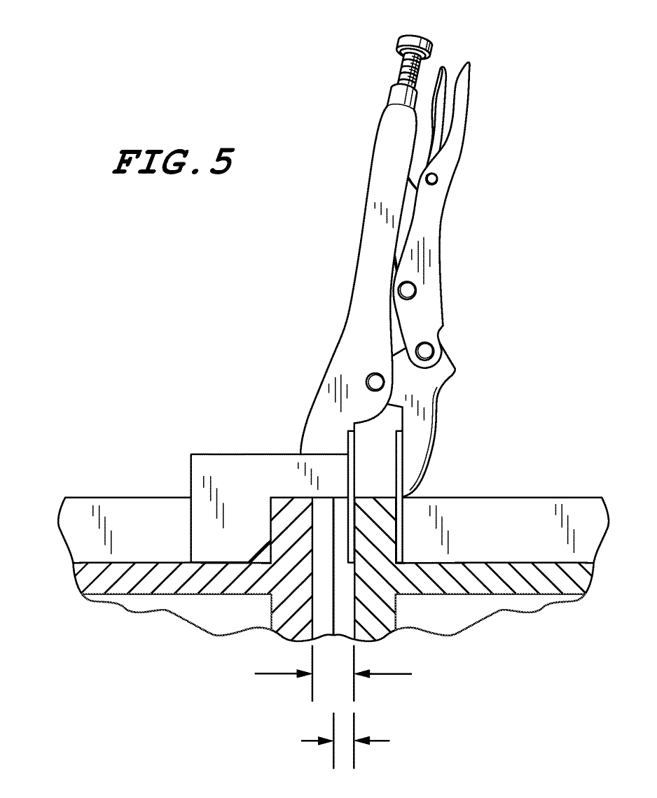

The invention is an attachment or permanent fixture to a flat jaw locking plier that could consists of a steel bracket, wood block or aluminum block that matches the typical size of a framed kitchen wall cabinet. The attachment can be locked onto the approximate top middle of the side panel on a framed cabinet and then can hold the cabinet weight when hooked on to an adjoining cabinet until the cabinet is attached. Then the tool can be easily removed to repeat the process. The attachment measures approximately 6-8 inches (The average framed kitchen wall cabinet is typically 12 inches deep) The attachment can be bolted to a locking plier or can be created as one tool that is permanently attached to the locking plier. In the drawings, FIGS. 1 through 5, you can see that the tool attaches and locks on to the cabinet being installed at the top approximate middle of the side panel, then can be lifted and attached to a second subsequent wall cabinet. To allow the cabinet to be screwed into the wall and adjoining cabinet with ease, since a carpenter or kitchen cabinet installer will not have to hold it in place at the same time securing it to the wall and adjoining cabinet.

1. I claim that the cabinet hanging clamp is an attachment to a locking plier with a bracket that has the purpose of attaching to the top center of the side panel of a framed cabinet, so that the plier locks on the cabinet prior to installation, then supports the weight of the cabinet as it is lifted and hung on to another cabinet. The clamp holds and aligns the cabinet in exact alignment to the previous cabinet installed, so that it can be attached to the wall and adjoining cabinet.

2. I claim that the other optional aspect of the cabinet hanging clamp can be made into a permanent 18 or 20 gauge metal bracket screwed to the top center side panel of a framed wall cabinet before installation without the use of the locking plier clamp.

3. I claim that another optional aspect of the cabinet hanging clamp can also be used to hold and align base cabinets until fastened.
